(19) United States
(12) Patent Application Publication
(10) Pub. No.: US 2005/0186434 A1
(43) Pub. Date: Aug. 25, 2005

(54) Thermosetting resin composition, adhesive film and multilayer printed wiring board using same

(75) Inventor: Shigeo Nakamura, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AJINOMOTO CO., INC., Tokyo (JP)

(21) Appl. No.: 11/044,225

(22) Filed: Jan. 28, 2005

(30) Foreign Application Priority Data
Jan. 28, 2004 (JP) 2004-019923

(51) Int. Cl. B32B 27/00; B32B 27/38; C08L 63/00; C08L 75/00

(52) U.S. Cl. 428/423.1; 428/413; 525/528

(57) ABSTRACT

Insulating layers, which are formed by using a thermosetting resin composition, which contains at least one aromatic cyanate compound having at least two cyanato groups in one molecule, and which has a minimum melt viscosity of less than 15000 (poise) and a melt viscosity at 160° C. of 15000 (poise) or more when a dynamic viscoelasticity measurement is conducted under conditions of a measurement initiation temperature of 60° C., a temperature-raising rate of 5° C./minute, and a frequency of 1 Hz/deg, or an adhesive film containing such composition, exhibit excellent diaelectric properties and excellent surface flatness.

### CROSS REFERENCES TO RELATED APPLICATIONS

This application claims priority to Japanese Patent Application No. 019923/2004, filed on Jan. 28, 2004, which is incorporated herein by reference in its entirety.

### BACKGROUND OF THE INVENTION

1. Field of the Invention

The present invention relates to thermosetting resin compositions which are useful as electric insulating materials. The present invention also relates to adhesive films which comprise such a thermosetting resin composition. The present invention further relates to multilayer printed wiring boards which contain an insulating layer formed by curing such a thermosetting resin composition.

2. Discussion of the Background

In recent years, an increase in computing processing speed and an enhancement in wiring density have been strongly desired in printed wiring boards to be used in electronic apparatus, communication apparatus, and the like. In view of such needs, a production technique of a build-up system, in which organic insulating layers and conductor layers are alternately piled up on a circuit substrate, has attracted attention as a method for producing a multilayer printed wiring board. As for an insulating resin which is presently used in the build-up system, a combination of an aromatic epoxy resin and a curing agent having an active hydrogen (for example, a phenolic curing agent, an amine-type curing agent, or a carboxylic acid-type curing agent) has mainly been used. The cured product obtained using these curing agents has well-balanced properties, but suffers from the defects that a hydroxyl group having a high polarity is generated by a reaction of an epoxy group and active hydrogen to decrease moisture resistance and electrical properties such as dielectric constant and dielectric dissipation factor. Especially for multilayer printed circuit boards used in the high-frequency region, an insulation material having a low dielectric dissipation factor has been required. However, with an ordinary insulation material containing an epoxy resin as a main component, the value of the dielectric dissipation factor (1 GHz, 23° C.) has been limited to from approximately 0.03 to 0.02.

On the other hand, it has long been known that a thermosetting cyanate compound having a cyanato group can provide a cured product which exhibits excellent dielectric properties and an example in which a thermosetting resin composition which contains a cyanate compound is applied to an insulating layer of a circuit substrate has been known (see, for example, WO03/099952). However, when the insulating layer is formed on the circuit substrate by using the thermosetting resin composition which contains the cyanate compound, the difference between a convex region and a concave region on the surface of the insulating layer caused by an irregularity of the circuit pattern becomes large and, accordingly, it has been difficult to form a fine circuit (see, FIG. 1). Therefore, a thermosetting resin composition which contains a cyanate compound which affords an insulation layer which exhibits an excellent flatness of its surface has been required.

### SUMMARY OF THE INVENTION

Accordingly, it is one object of the present invention to provide novel thermosetting resin compositions which are useful as electric insulating materials.

It is another object of the present invention to provide novel adhesive films which comprise such a thermosetting resin composition.

It is another object of the present invention to provide novel multilayer printed wiring boards which contain an insulating layer formed by curing such a thermosetting resin composition.

It is another object of the present invention to provide a method for making such multilayer printed wiring boards.

These and other objects, which will become apparent during the following detailed description, have been achieved by the inventor's discovery that there is a relationship between the curing property and the flatness of a surface of a cured article (insulating layer) of a thermosetting resin composition which contains a cyanate compound and, also, that the curing property can be indicated by the melt viscosity value of the thermosetting resin composition and, further, that an insulating layer which has an excellent surface flatness can be obtained by controlling the melt viscosity value to be of a specified value.

Thus, the present invention provides the following embodiments:
(1) A thermosetting resin composition, comprising:
(a) at least one aromatic cyanate compound having at least two cyanato groups in one molecule,
wherein said thermosetting resin composition exhibits a minimum melt viscosity of less than 15000 (poise) and a melt viscosity at 160° C. of 15000 (poise) or more when a dynamic viscoelasticity measurement is conducted under conditions of a measurement initiation temperature of 60° C., a temperature-raising speed of 5° C./min, and a frequency of 1 Hz/deg.

(2) A thermosetting resin composition, comprising:
(a) at least one aromatic cyanate compound having at least two cyanato groups in one molecule; and
(b) at least one aromatic epoxy resin having at least two epoxy groups in one molecule,
wherein said thermosetting resin composition exhibits a minimum melt viscosity of less than 15000 (poise) and a melt viscosity at 160° C. of 15000 (poise) or more when a dynamic viscoelasticity measurement is conducted under conditions of a measurement initiation temperature of 60° C., a temperature-raising speed of 5° C./min, and a frequency of 1 Hz/deg.

(3) A thermosetting resin composition, comprising:
(a) at least one aromatic cyanate compound having at least two cyanato groups in one molecule;
(b) at least one aromatic epoxy resin having at least two epoxy groups in one molecule; and
(c) at least one phenoxy resin having a weight-average molecular weight of from 5000 to 100000,
wherein said thermosetting resin composition exhibits a minimum melt viscosity of less than 15000 (poise) and a melt viscosity at 160° C. of 15000 (poise) or more when a dynamic viscoelasticity measurement is conducted under conditions of a measurement initiation temperature of 60° C., a temperature-raising speed of 5° C./min, and a frequency of 1 Hz/deg.

(4) A thermosetting resin composition, comprising:
(a) at least one aromatic cyanate compound having at least two cyanato groups in one molecule;
(b) at least one aromatic epoxy resin having at least two epoxy groups in one molecule; and
(c) at least one phenoxy resin having a biphenyl skeleton and having a weight-average molecular weight of from 5000 to 100000,
wherein said thermosetting resin composition exhibits a minimum melt viscosity of less than 15000 (poise) and a melt viscosity at 160° C. of 15000 (poise) or more when a dynamic viscoelasticity measurement is conducted under conditions of a measurement initiation temperature of 60° C., a temperature-raising speed of 5° C./min, and a frequency of 1 Hz/deg.

(5) The thermosetting resin composition as described in the aforementioned (2), wherein the ratio of the epoxy groups of the aromatic epoxy resin to the cyanato groups of the aromatic cyanate compound in the thermosetting resin composition is from 1:0.5 to 1:3.

(6) The thermosetting resin composition as described in the aforementioned (3) to (4), wherein the ratio of the epoxy groups of the aromatic epoxy resin to the cyanato groups of the aromatic cyanate compound in the thermosetting resin composition is from 1:0.5 to 1:3; and the phenoxy resin is mixed in an amount of from 3 to 40 parts by weight based on 100 parts by weight of a total weight of the aromatic epoxy resin and the aromatic cyanate compound.

(7) The thermosetting resin composition as described in the aforementioned (1) to (6), wherein the minimum melt viscosity is less than 10000 (poise); and the melt viscosity at 160° C. is 20000 (poise) or more.

(8) The thermosetting resin composition as described in the aforementioned (1) to (6), wherein the minimum melt viscosity is less than 8000 (poise); and the melt viscosity at 160° C. is 50000 (poise) or more.

(9) The thermosetting resin composition as described in the aforementioned (1) to (8), wherein the temperature showing the minimum melt viscosity is from 80° C. to 150° C.

(10) The thermosetting resin composition as described in the aforementioned (1) to (8), wherein the temperature showing the minimum melt viscosity is from 90° C. to 140° C.

(11) The thermosetting resin composition as described in the aforementioned (1) to (8), wherein the temperature showing the minimum melt viscosity is from 90° C. to 130° C.

(12) An adhesive film, comprising a layer of a thermosetting resin composition as described in the aforementioned (1) to (11) formed on a supporting film.

(13) A multilayer printed wiring board, which is prepared by a process comprising:
(a) laminating the adhesive film as described in the aforementioned (12) on one face or both faces of a circuit substrate;
(b) forming an insulating layer by thermally curing the thermosetting resin composition while either removing or not removing the supporting film;
(c) in a case of not removing the supporting film in the step (2), drilling the circuit substrate while either removing or not removing the supporting film;
(d) in a case of not removing the supporting film in the steps (2) and (3), removing the supporting film and, then, roughening a surface of the insulating layer;
(e) forming a conductor layer on the insulating layer; and
(f) subjecting the conductor layer to a circuit formation.

(14) The multilayer printed wiring board as described in the aforementioned (13), wherein the thermally curing is performed for a period of time in the range of from 20 minutes to 180 minutes at a temperature in the range of from 150° C. to 220° C.

(15) The multilayer printed wiring board as described in the aforementioned (13) to (14), wherein the difference between a convex region and a concave region on the surface of the insulating layer obtained by thermally curing the thermosetting resin composition is 4.5 μm or less.

(16) A method for producing a multilayer printed circuit board, comprising:
(a) laminating the adhesive film as described in the aforementioned (12) on one face or both faces of a circuit substrate;
(b) forming an insulating layer by thermally curing the thermosetting resin composition while either removing or not removing the supporting film;
(c) in a case of not removing the supporting film in the step (2), drilling the circuit substrate while either removing or not removing the supporting film;
(d) in a case of not removing the supporting film in the steps (2) and (3), removing the supporting film and, then, roughening a surface of the insulating layer;
(e) forming a conductor layer on the insulating layer; and
(f) subjecting the conductor layer to a circuit formation.

(17) The method for producing the multilayer printed circuit board as described in the aforementioned (16), wherein the thermally curing is performed for a period of time in the range of from 20 minutes to 180 minutes and at a temperature in the range of from 150° C. to 220° C.

(18) The method for producing the multilayer printed circuit board as described in the aforementioned (16) or (17), wherein the difference between a convex region and a concave region on the surface of the insulating layer obtained by thermally curing the thermosetting resin composition is 4.5 μm or less.

The cured article of the thermosetting resin composition according to the present invention has excellent dielectric properties, when formed as an insulating layer on a circuit substrate. Moreover, the flatness of a surface of the insulating layer is also excellent. Therefore, when the thermosetting resin composition according to the present invention or an adhesive film comprising the thermosetting resin composition are used, an insulating layer with excellent dielectric properties and capable of having a circuit having a fine pattern formed on it, is obtained.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1 is a conceptual diagram showing a difference between a convex region and a concave region of an insulating layer formed on a circuit substrate;

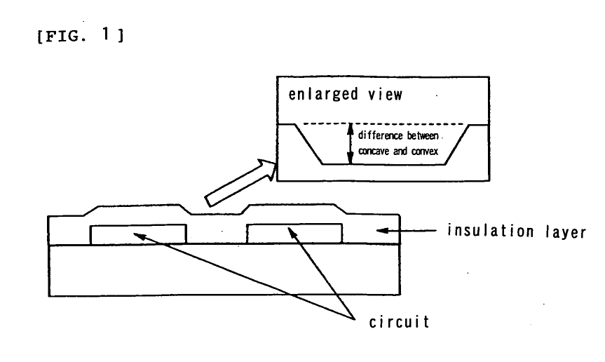

FIG. 2 shows the results of dynamic viscoelasticity measurements of Examples 1 and 2 and Comparative Example 1 (◯, Example 1; □, Example 2; Δ, Comparative Example 1); and

FIG. 3 shows the results of dynamic viscoelasticity measurements of Example 3 and Comparative Example 2 (□, Example 3; ◯, Comparative Example 2).

### DETAILED DESCRIPTION OF THE PREFERRED EMBODIMENTS

Hereinafter, the present invention will be described in detail.

In the context of the present invention the term “an aromatic cyanate compound having at least two cyanato groups in one molecule” denotes a cyanate compound having at least two cyanato groups in one molecule and, further having an aromatic skeleton in the molecule. Preferred examples of such aromatic cyanate compounds each having at least two cyanato groups in one molecule include bisphenol A dicyanate, polyphenol cyanate (oligo(3-methylene-1,5-phenylene cyanate), 4,4′-methylenebis(2,6-dimethyl phenyl cyanate), 4,4′-ethylydene diphenyl dicyanate, hexafluorobisphenol A dicyanate, and a prepolymer which is produced by allowing a portion of any one of these cyanate compounds to have a triazine structure. These cyanate compounds may each be used individually or may be used in a mixture of two or more types.

A ratio of “the aromatic cyanate compound having at least two cyanato groups in one molecule” to be mixed in the thermosetting resin composition is preferably 25% by weight or more and, more preferably, in the range of from 35 to 90% by weight, based on the total weight of the thermosetting resin composition.

As for the thermosetting resin to be contained in the thermosetting resin composition, for example, an epoxy resin having at least two epoxy groups in one molecule, a polymerized article between a bismaleimide compound and a diamine compound, a cyanate ester compound, a bismaleimide compound, a bisallylnazide resin, a benzoxazine compound and a vinyl benzyl ether compound can be mentioned. These thermosetting resins may be used in mixtures of two types or more.

Further, since the cyanato compound is required to be cured for a relatively long period of time at a high temperature, the epoxy resin is preferably simultaneously used for lowering curing temperature. Since a main reaction for the epoxy group of the epoxy resin is a reaction with the cyanato group of the cyanate compound and formation of an oxazoline group, the generation of a hydroxyl group, which deteriorates the dielectric loss tangent after thermosetting, or the persistence of cyanato groups which deteriorates the dielectric loss tangent is controlled. As for the epoxy resin, an aromatic epoxy resin having at least two epoxy groups in one molecule can favorably be used.

The term “an aromatic epoxy resin having at least two epoxy groups in one molecule” denotes an epoxy resin having at least two epoxy groups in one molecule and, further, having an aromatic skeleton in the molecule. Preferred examples of such aromatic epoxy resins each having at least two epoxy groups in one molecule include a bisphenol A-type epoxy resin, a bisphenol F-type epoxy resin, a bisphenol S-type epoxy resin, a phenol novolak-type epoxy resin, an alkyl phenol novolak-type epoxy resin, a biphenyl-type epoxy resin, a dicyclopentadiene-type epoxy resin, an epoxidized compound of a condensate between any one of phenols and an aromatic aldehyde having a phenolic hydroxyl group, a naphthalene-type epoxy resin, triglycidyl isocyanulate and, further, a brominated epoxy resin or a phosphorous-modified epoxy resin of any one of these epoxy resins. These epoxy resins may be used each individually or in combinations of two or more types.

As for the compounding ratio of the epoxy resin and the cyanate compound in the thermosetting resin composition, the ratio of the number of epoxy group present in one molecule of the epoxy resin to the number of cyanato groups present in one molecule of the cyanate compound is preferably in the range of from 1:0.5 to 1:3. When the ratio is outside this range, a substantially low dielectric loss tangent sometimes cannot be obtained due to remaining unreacted epoxy group or cyanato group after curing. Further, when a compound having an epoxy group of any one of epoxy resins other than “the aromatic epoxy resin having at least two epoxy groups in one molecule” or a compound having a cyanato group of any one of cyanate compounds other than “the aromatic cyanate compound having at least two cyanato groups in one molecule” is contained in the thermosetting resin composition, the aforementioned range of the ratio between the number of epoxy groups and the number of cyanato groups is intended to include these components. Namely, the ratio between the total number of epoxy groups and the total number of cyanato groups present in the thermosetting resin composition is preferably set to be in the range of from 1:0.5 to 1:3.

The compounding ratio of the total of the “aromatic epoxy resin having at least two epoxy groups in one molecule” and the “aromatic cyanate compound having at least two cyanato groups in one molecule” in the thermosetting resin composition is preferably 25% by weight or more and, more preferably, in the range of from 30 to 90% by weight, based on the total weight of the thermosetting resin composition.

Further, in a resin composition comprising the cyanate compound and the epoxy resin, curing is accelerated by compounding a phenoxy resin and, then, the pot life of the thermosetting resin composition is stabilized. The phenoxy resin is a polymer comprising a reaction product between a 2-functional epoxy resin and a bisphenol compound and, since a hydroxyl group present in the molecule thereof provides a curing accelerating action of the epoxy group and cyanate group, it is considered that sufficient cured physical properties (thermal resistance, low dielectric loss tangent) can be obtained even at a relatively low curing temperature. Further, when the epoxy resin contains a hydroxyl group, a curing accelerating action can be noticed; however, it has been known that such hydroxyl group as described above deteriorates the pot life of the resin composition. Still further, by compounding the phenoxy resin, the roughening property of the cured article of the epoxy resin by an oxidizing agent is enhanced, to thereby improve the adhesive properties of a conductor layer formed by plating. As for the phenoxy resin, a “phenoxy resin having a weight-average molecular weight of from 5000 to 100000” can favorably be used.

Preferred examples of such phenoxy resins each having a weight-average molecular weight of from 5000 to 100000 include bisphenol A-types: PHENOTOHTO YP50 (trade name; available from Tohto Kasei Co., Ltd.); and E-1256 (trade name; available from Japan Epoxy Resins Co., Ltd.), and brominated phenoxy resin: PHENOTOHTO YPB40 (trade name; available from Tohto Kasei Co., Ltd.). Particularly, phenoxy resins having a biphenyl skeleton and, also, a weight-average molecular weight of from 5000 to 100000 are preferable from the standpoint of thermal resistance, moisture resistance, and curing accelerating action. Specific examples of such phenoxy resins include a phenoxy resin comprising a reaction product between a biphenyl-type epoxy resin (YX4000: trade name; available from Japan Epoxy Resins Co., Ltd.) and any one of various types of bisphenol compounds. As for other examples, YL6742BH30, YL6835BH40, YL6953BH30, YL6954BH30, YL6974BH30, YX8100BH30 can be mentioned. These phenoxy resins can be used each individually or in combinations of two or more types.

The phenoxy resin having a weight-average molecular weight of from 5000 to 100000 improves not only the curing accelerating action but also the flexibility of the adhesive film and a prepreg and, further, facilitates the handling thereof and improves the mechanical strength and flexibility of the cured product. Still further, roughening of the cured product by an oxidizing agent becomes practicable. When the weight-average molecular weight of the phenoxy resin is less than 5000, the aforementioned effects become insufficient, while, when it is over 100000, the solubility thereof in the epoxy resin and an organic solvent is remarkably deteriorated, to thereby become impracticable.

The amount of the phenoxy resin to be mixed is, although depending on the types, preferably in the range of from 3 to 40 parts by weight and, particularly preferably, in the range of from 5 to 25 parts by weight, based on 100 parts by weight of the total weight of the epoxy resin and the cyanate compound. When it is less than 3 parts by weight, the curing accelerating effect of a resin composition sometimes appears to be insufficient and, then, when the resin composition is laminated on the circuit substrate, or when the thus-laminated resin composition is subjected to thermosetting, the flowability of the resin composition becomes unduly large and, then, the thickness of the insulating layer tends to be uneven. Further, roughening of the cured article for forming the conductor layer is hardly obtainable. While, when it is over 40 parts by weight, the functionality of the phenoxy resin becomes excessive and, then, a substantially low dielectric loss tangent is hardly obtainable and, further, since the flowability of the resin composition at the time of laminating it on the circuit substrate becomes unduly low, the filling of via-holes or through-holes which exist in the circuit substrate with the resin tends to be performed only insufficiently.

The total ratio of three components, namely, the “aromatic epoxy resin having at least two epoxy groups in one molecule”, the “aromatic cyanate compound having at least two cyanato groups in one molecule” and the “phenoxy resin having a weight-average molecular weight of from 5000 to 100000” to be mixed in the thermosetting resin composition is preferably 25% by weight or more and, more preferably, in the range of from 30 to 90% by weight, based on the total weight of the thermosetting resin composition.

The thermosetting resin composition according to the present invention is adjusted such that, when a dynamic viscoelasticity is measured under conditions of a measurement initiation temperature of 60° C., a temperature raising speed of 5° C./minute, and a frequency of 1 Hz/deg, the minimum melt viscosity becomes less than 15000 (poise). In a case in which it becomes 15000 (poise) or more, when the thermosetting resin composition is laminated as an adhesive film on the circuit substrate, the flowability of the resin deteriorates, to thereby cause difficulty in performing lamination by using a vacuum laminator. Therefore, it is adjusted such that the minimum melt viscosity becomes, more preferably, less than 10000 and, still more preferably, less than 8000 (poise). The lowest value is not particularly defined; however, it is ordinarily 300 (poise) or more and, preferably, 500 (poise) or more. In order to allow the lowest value to be in the aforementioned range, conditions such as melt viscosity of the cyanate compound, those of other thermosetting resins which are simultaneously used such as the epoxy resin and the phenoxy resin, the particle diameter of an inorganic filler, and the amount thereof to be mixed, the drying condition at the time of making a film, and the amount of residual solvent are appropriately adjusted. The temperature range in which the thermosetting resin composition according to the present invention exhibits the aforementioned minimum melt viscosity value is in the range of ordinarily from 80 to 150° C., preferably from 90 to 140° C. and, more preferably, from 90 to 130° C.

Further, in a case in which the thermosetting resin composition according to the present invention is heated under conditions of an initiation temperature of 60° C. and a temperature raising speed of 5° C./minute, when the dynamic viscoelasticity measurement is performed under conditions of a measurement initiation temperature of 60° C., a temperature raising speed of 5° C./minute, and a frequency of 1 Hz/deg, the thermosetting resin composition according to the present invention is adjusted such that a melt viscosity at 160° C. becomes 15000 (poise) or more. When it is less than 15000 (poise), after the thermosetting resin composition is laminated on the circuit substrate and subjected to thermosetting, the flatness of the surface remarkably deteriorates. Therefore, it is more preferably adjusted so as to be 20000 (poise) or more and, more preferably 50000 (poise) or more. The maximum value thereof is not particularly defined; however, it is ordinarily 5000000 (poise) or less and, preferably, 3000000 (poise) or less.

The melt viscosity can be measured by using a dynamic viscoelasticity measuring apparatus. As for the dynamic viscoelasticity measuring apparatus available in the market, a dynamic viscoelasticity measuring apparatus Rheosol-G3000 (trade name; available from UBM Co., Ltd.) can be mentioned.

The methods for adjusting the melt viscosity at 160° C. are not particularly limited, and the melt viscosity can be adjusted by controlling the amount of a curing accelerating agent, curing catalyst, or the like of the thermosetting resin to be added. Examples of such curing accelerating agents include organic phosphine-type compounds such as triphenyl phosphine, and imidazole-type compounds such as 2-ethyl-4-methyl imidazole. Examples of such curing catalysts include organic metallic compounds. When the thermosetting resin according to the present invention contains an epoxy resin, the organic metallic compound can favorably be used as a curing catalyst in a system in which an epoxy resin composition and the cyanate compound are simultaneously used. As the amount of the curing accelerating agent or the curing catalyst to be added becomes larger, the curing speed becomes higher, and the melt viscosity at 160° C. tends to be larger. Further, according to the present invention, although a minimum melt viscosity of the thermaosetting resin composition is adjusted to be less than 15000 (poise), preferably less than 10000 (poise) and, more preferably, less than 8000 (poise), the thermosetting resin composition comprising, as a main component, the cyanate compound is low in curing speed, when the minimum melt viscosity is set at such a low value as described above, a value of the melt viscosity at 160° C. also indicates such a low value as below 15000 (poise). Therefore, in order to allow the melt viscosity to be 15000 (pose) or more, it is necessary to raise the curing speed by adding a curing accelerating agent, a curing catalyst, or the like. On the other hand, when any one of these agents and/or catalysts is added in an amount more than necessary, since the minimum melt viscosity tends to be raised, it becomes difficult to maintain the minimum melt viscosity under the condition of less than 15000 (poise). Thus, the amount of the curing accelerating agent or the curing catalyst to be added is appropriately adjusted so as to satisfy the aforementioned conditions in accordance with melt viscosity properties of the thermosetting resin composition.

Examples of such organic metallic compounds include organic copper compounds such as copper (II) acetylacetonate, organic zinc compounds such as zinc (II) acetylacetonate, and organic cobalt compounds such as cobalt (II) acetylacetonate and cobalt (III) acetylacetonate.

In order to reduce the coefficient of thermal expansion of the insulating layer to be optionally formed, an inorganic filler may be added to the thermosetting resin composition according to the present invention. The amount of the inorganic filler to be added differs depending on the required properties or function of the thermosetting resin composition according to the present invention, but it is ordinarily in the range of from 10 to 75% by weight and, preferably, in the range of from 20 to 65% by weight based on 100% by weight of the thermosetting resin composition.

Examples of such inorganic filler include silica, alumina, barium sulfate, talc, clay, mica powder, aluminum hydroxide, magnesium hydroxide, calcium carbonate, magnesium carbonate, magnesium oxide, boron nitride, aluminum borate, barium titanate, strontium titanate, calcium titanate, magnesium titanate, bismuth titanate, titanium oxide, bariun zirconate and calcium zirconate. Silica is particularly preferred. The inorganic filler preferably has an average particle diameter of 5 μm or less. When the average particle diameter is over 5 μm, it is sometimes difficult to stably form a fine pattern at the time of forming a circuit pattern on the conductor layer. Further, in order to enhance the moisture resistance, the surface of the inorganic filler is preferably treated with a surface treating agent such as a silane coupling agent.

Further, the thermosetting resin composition of the present invention can optionally contain other thermosetting resins, thermoplastic resins, or additives other than the components thereof so long as the effects of the present invention are not impaired. Examples of the thermosetting resins include, besides a monofunctional epoxy resin as a diluent agent, an alicyclic multifunctional epoxy resin, a rubber-modified epoxy resin, an acid anhydride-type compound as a curing agent for an epoxy resin, a blocked isocyanate resin, a xylene resin, a radical initiator and a polymerizable resin. Examples of the thermoplastic resins include a polyimide resin, a polyamideimide resin, a polyether imide resin, a polysulfone resin, a polyether sulfone resin, a polyphenylene ether resin, a polycarbonate resin, a polyether ether ketone resin, and a polyester resin. Examples of the additives include an organic filler such as silicone powder, nylon powder, or fluorine powder; a thickening agent such as orben or bentone; a silicone-type, a fluorine-type or a polymeric defoaming agent or leveling agent; an adhesion improver such as an imidazole-type, a thiazole-type or a triazole-type silane coupling agent; and a coloring agent such as Phthalocyanine Blue, Phthalocyanine Green, Iodine Green, Disazo Yellow, or carbon black.

Since the thermosetting resin composition according to the present invention comprises, as a main component, the cyanate compound, it forms a cured product excellent in thermal resistance and electric properties. For example, it is possible to form a cured product which satisfies dielectric loss tangent conditions (for example, 0.015 or less under conditions of a measurement frequency of 1 GHz and a temperature of 23° C.) required in a printed wiring board which is used in the high frequency region.

The adhesive film according to the present invention can be produced by firstly dissolving the thermosetting resin composition in an organic solvent to form a resin varnish, coating this varnish on a base film (support film), and drying the solvent by a step of hot air blowing or the like.

Those skilled in the art can appropriately set preferable drying conditions through a simple experiment. For example, a varnish containing from 30 to 60% by weight of organic solvent can be dried under conditions of from about 80 to about 100° C. and from about 3 to about 10 minutes. The amount of the organic solvent remaining in the thermosetting resin composition is defined as being ordinarily 10% by weight or less and, preferably, 5% by weight or less.

The adhesive film according to the present invention may be made by laminating a supporting film having a thickness of preferably from 10 to 200 μm with a thermosetting resin composition layer having a thickness which is not less than a thickness of a conductor layer of the circuit substrate to be laminated and is preferably in the range of from 10 to 150 μm.

On the face of the thermosetting resin composition layer which is not in contact with the supporting film, a protective film in accordance with a supporting film can further be applied. The thickness of the protective film is preferably defined to be in the range of from 1 to 40 μm. By performing protection by using the protective film, the attachment of dust and the generation of scratches on the surface of the thermosetting resin composition layer can be prevented. The adhesive film can also be stored after being wound into a roll.

Examples of the supporting films include polyolefins such as polyethylene and polyvinyl chloride; polyesters such as polyethylene terephthalate (hereinafter, referred to also as “PET” in short) and polyethylene naphthalate; polycarbonates; polyimide; release paper; and metal foils such as a copper foil and an aluminum foil. The supporting film may be treated with mud processing, corona processing, or release processing.

Examples of the organic solvents to be used for preparing the varnish include ketones such as acetone, methyl ethyl ketone, and cyclohexanone; acetate esters such as ethyl acetate, butyl acetate, Cellosolve acetate, propylene glycol monomethyl ether acetate, and Carbitol acetate; Cellosolves such as Cellosolve and butyl Cellosolve; Carbitols such as Carbitol and butyl Carbitol; aromatic hydrocarbons such as toluene and xylene; dimethylformamide; dimethylacetamide; and N-methylpyrrolidone. These organic solvents may be used singly or in combinations of two or more types.

As for the substrates to be used in the circuit substrate, a glass-epoxy substrate, a metallic substrate, a polyester substrate, a polyimide substrate, a BT resin substrate, a thermosetting polyphenylene ether substrate, and the like can be used. Further, the term “circuit substrate” as used herein refers to an article in which a patterned conductor layer (circuit) is formed on one face or both faces of such substrate as described above. Further, in a multilayer printed wiring board in which conductor layers and insulating layers are alternately piled up, an article in which one face or both faces of an outermost layer of the multilayer printed wiring board are made to be the conductor layer (circuit) is also included in the circuit substrate according to the present invention. Still further, the surface of the conductor layer may be subjected to a roughening treatment such as a black oxide treatment in advance.

The adhesive film according to the present invention can favorably be laminated on the circuit substrate by using a vacuum laminator. Such lamination may be performed either batch-wise or continuously by using a roll. Further, before the lamination is performed, the adhesive film and the circuit substrate may optionally be preheated. Examples of commercially available vacuum laminators include a vacuum applicator manufactured by Nichigo-Morton Co., Ltd., a vacuum & pressure-type laminator manufactured by Meiki Co., Ltd., a roll-type dry coater manufactured by Hitachi Industries Co., LTD. and a vacuum laminator manufactured by Hitachi AIC Inc.

At the time of the lamination, in a case in which the adhesive film has a protective film, the protective film is removed and, then, the adhesive film is contact-bonded on the circuit substrate while applying a pressure and heat. The lamination is preferably performed under conditions of a temperature of 70 to 140° C., a contact bonding pressure of from 1 to 11 kgf/cm² (from 9.8×10⁴ to 107.9×10⁴ N/m²), and a reduced pressure of 20 mmHg (26.7 hPa) or less in terms of an air pressure. After the lamination, the resulting laminate is cooled to around room temperature and, then, the supporting film is optionally removed and, thereafter, the thermosetting resin composition which is laminated on the circuit substrate is heat-cured. Conditions of such heat-curing are selected within the range of from 150° C. to 220° C. and from 20 minutes to 180 minutes and, on this occasion, more preferable conditions are from 160° C. to 200° C. and from 30 minutes to 120 minutes. In the case where a supporting film which has been subjected to a releasable treatment is used, the supporting film may be removed after the heat-curing. On the other hand, when a metallic foil is used, since the supporting film can be utilized as it is as a conductor layer, it is sometimes not necessary to remove it.

The surface of the insulating layer which is obtained by laminating the adhesive film of the invention on the circuit substrate and, then, curing the resultant thermosetting resin composition layer in such a manner as described above may have a difference between a convex region (or peak) and a concave region (or trough) of 4.5 μm or less, thereby being capable of forming the insulating layer which is excellent in flatness. Further, in forming a circuit pattern by the build-up method which forms the conductor layer on the surface of the insulating layer, when the difference between the convex region (or peak) and the concave region (or trough) is over 4.5 μm, a dry film for forming the pattern can not follow the contours of such convexes and concaves and, accordingly, it becomes difficult to perform such a pattern formation.

After the insulating layer as a cured article of the thermosetting resin composition is formed in such a manner as described above, the insulating layer may optionally be subjected to perforation by a drill, a laser or the like, to thereby form a via-hole or a through-hole. When the supporting film subjected to a release treatment is used, the supporting film may be removed after such perforating processing.

Next, a conductor layer is formed by either dry plating or wet plating. As for the dry plating, a known method such as deposition, sputtering, or ion-plating can be utilized. In the wet plating, the surface of the cured thermosetting resin composition layer (insulation layer) is first roughened with an oxidizing agent such as a permanganate (potassium permanganate, sodium permanganate or the like), a bichromate, ozone, hydrogen peroxide/sulfuric acid or nitric acid to form an uneven anchor. As the oxidizing agent, a sodium hydroxide aqueous solution of potassium permanganate, sodium permanganate or the like (alkaline permanganate aqueous solution) is preferably used. Then, the conductor is formed by a method which is a combination of electroless plating and electroplating. It is also possible that a plating resist having an opposite pattern to that of the conductor layer is formed and the conductor layer is formed by electroless plating alone. As the subsequent patterning method, for example, a subtractive method or a semi-additive method which is known to a skilled person can specifically be used.

Other features of the invention will become apparent in the course of the following descriptions of exemplary embodiments which are given for illustration of the invention and are not intended to be limiting thereof.

### EXAMPLES

### Example 1

40 parts by weight of a bisphenol A dicyanate prepolymer (trade name: BA230S75; available from LONZA Japan Co., Ltd.; a methyl ethyl ketone (MEK) varnish having a cyanate equivalent of about 232 and a nonvolatile content of 75%), 15 parts by weight of a bisphenol A-type epoxy resin (trade name: Epikote 828EL; available from Japan Epoxy Resins Co., Ltd.; epoxy equivalent: 185), 30 parts by weight of a biphenyl skeleton-containing phenoxy resin varnish (trade name: YL6954BH30; available from Japan Epoxy Resins Co., Ltd.; a MEK/cyclohexanone varnish having a weight-average molecular weight of 38000 and a nonvolatile content of 30%), 4 parts by weight of a 1% N,N-dimethyl formamide solution of cobalt (II) acetyl acetonate, and 40 parts by weight of spherical silica were mixed to prepare a thermosetting resin composition varnish. The thus-prepared varnish was applied on a PET film having a thickness of 38 μm by a die coater in such an amount that the thickness after drying was 40 μm and, then, dried for 10 minutes at from 80 to 120° C., to thereby obtain an adhesive film.

### Example 2

The completely same resin composition as in Example 1, except for using 2 parts by weight of the 1% N,N-dimethyl formamide solution of cobalt (II) acetyl acetonate, was applied in an amount to obtain a thickness after drying of 40 μm on a PET film having a thickness of 38 μm by using a die coater and dried for 10 minutes at from 80 to 120° C., to thereby obtain an adhesive film.

### Example 3

40 parts by weight of a bisphenol A dicyanate prepolymer (trade name: BA230S75; available from LONZA Japan Co., Ltd.; an MEK varnish having a cyanate equivalent of about 232 and a nonvolatile content of 75%), 40 parts by weight of a vinyl benzyl ether of a Xylok-type phenol resin (trade name: SA-1X; available from Showa Highpolymer Co., Ltd.; a toluene varnish having a nonvolatile content of 75%), 4 parts by weight of a 1% N,N-dimethyl formamide solution of cobalt (II) acetyl acetonato, and 40 parts by weight of spherical silica were mixed to prepare a thermosetting resin composition varnish. The thus-prepared varnish was applied on a PET film having a thickness of 38 μm by a die coater in an amount to obtain a thickness after drying of 40 μm and, then, dried for 10 minutes at from 80 to 120° C., to thereby obtain an adhesive film.

### Comparative Example 1

The completely same resin composition as in Example 1, except for using one part by weight of the 1% N,N-dimethyl formamide solution of cobalt (II) acetyl acetonate, was applied in an amount to obtain a thickness after drying of 40 μm on a PET film having a thickness of 38 μm by using a die coater and dried for 10 minutes at from 80 to 120° C., to thereby obtain an adhesive film.

### Comparative Example 2

The completely same resin composition as in Example 3, except for using 1.5 part by weight of the 1% N,N-dimethyl formamide solution of cobalt (II) acetyl acetonato, was applied in an amount to obtain a thickness after drying of 40 μm on a PET film having a thickness of 38 μm by using a die coater and dried for 10 minutes at from 80 to 120° C., to thereby obtain an adhesive film.

Measurement of the Curing Behavior of the Resin Compositions.

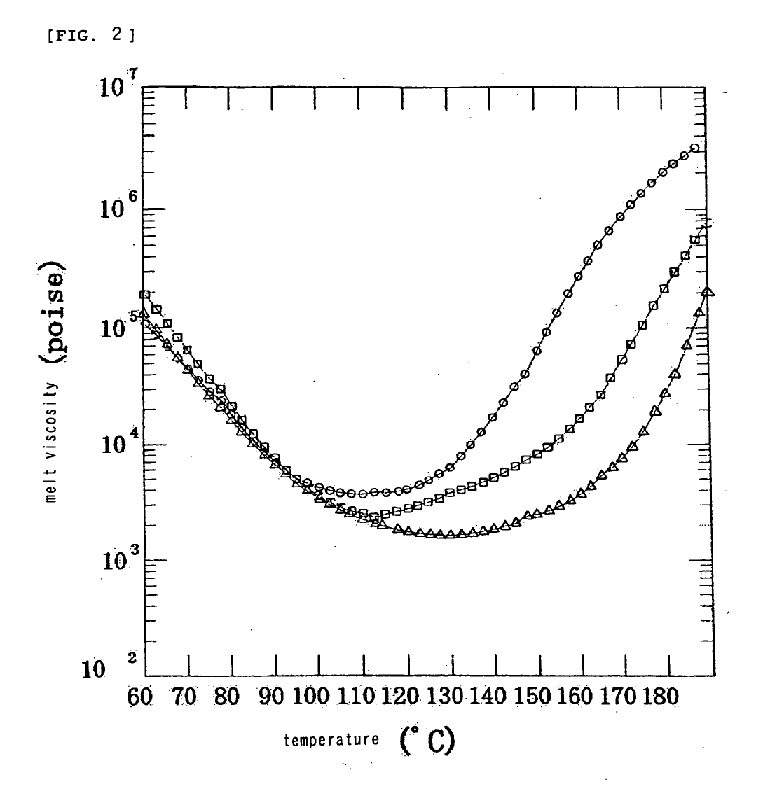

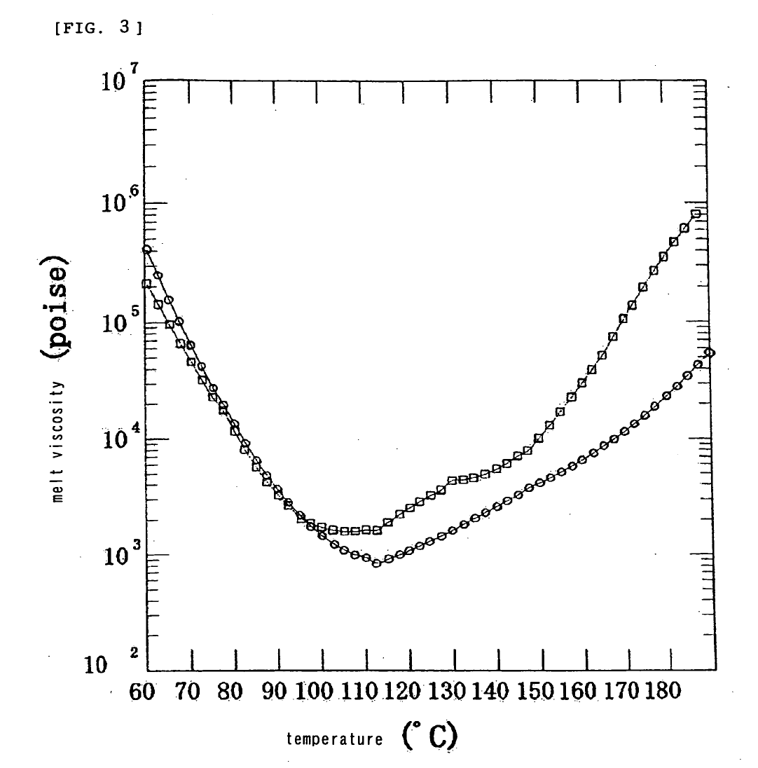

The adhesive films containing a thermosetting resin composition layer obtained in each of Examples 1 to 3 and Comparative Examples 1 and 2 were subjected to a dynamic viscoelasticity measurement by using a model Rheosol-G3000 (trade name; available from UBM Co., Ltd.). The measurement results of Examples 1 and 2, and Comparative Example 1 are shown in FIG. 2, while those of Example 3 and Comparative Example 2 are shown in FIG. 3. these measurements were conducted using conditions of a temperature-raising speed of 5° C./minute starting from an initiation temperature of 60° C., a measurement interval temperature of 2.5° C., and a frequency of 1 Hz/deg. The minimum melt viscosity values and the melt viscosity values at 160° C. are shown in Table 1.

TABLE 1

| | | | | Compar- | Compar- |
|---|---|---|---|---|---|
| | | | | ative | ative |
| | Example 1 | Example 2 | Example 3 | Example 1 | Example 2 |
| Minimum | 3830 | 2410 | 1620 | 1680 | 856 |
| melt | (108° C.) | (113° C.) | (107° C.) | (132° C.) | (113° C.) |
| viscosity | | | | | |
| [poise] | | | | | |
| Melt | 290000 | 16600 | 24000 | 3840 | 6800 |
| viscosity at | | | | | |
| 160° C. | | | | | |
| [poise] | | | | | |

The values in a parenthesis ( ) indicates the temperature at which the minimum melt viscosity was detected.

The values in a parenthesis ( ) indicates the temperature at which the minimum melt viscosity was detected.
Evaluation of the Surface Flatness of the Resin Compositions.

The adhesive films obtained in each of Examples 1 to 3 and Comparative Examples 1 and 2 were vacuum-laminated on a test coupon of a comb-shaped pattern having a conductor thickness of 35 μm and a line/space of 160 μm/160 μm by using a vacuum laminator attached with a heat-press under conditions of a temperature of 110° C., a pressure of 5 kgf/cm² (49×10⁴ N/m²), a barometric pressure of 5 mmHg (6.7 hPa) or less, and a pressing period time of 30 seconds and, then, heat-pressed for 60 seconds at a temperature of 110° C. under a pressure of 5 kgf/cm² (49×10⁴ N/m²). Subsequently, the PET film was removed and, then, the resultant article was heat-cured for 30 minutes at 170° C. The differences between a convex region (peak height) and a concave region (valley depth) on the surfaces of the insulating layers on the resultant circuit patterns of the thus-heat-cured articles were measured by means of a laser coherent surface profiler (trade name: NT3300; available from Veeco Instruments Inc.). Further, the dielectric constant and dielectric loss tangent were measured (23° C.; measuring frequency: 1 GHz) in accordance with IPC-TM650 2, 5, 5, 9. The measurement results on the difference between the convex and the concave (average value; n=3), the dielectric constant, and the dielectric loss tangent are shown in Table 2.

TABLE 2

| | Difference between | Dielectric | Dielectric loss |
|---|---|---|---|
| | convex and | constant | tangent |
| | concave (μm) | (1 GHz) | (1 GHz) |
| Example 1 | 2.5 | 3.1 | 0.010 |
| Example 2 | 4 | 3.1 | 0.010 |
| Example 3 | 2.5 | 2.9 | 0.007 |
| Comparative | 6 | 3.1 | 0.010 |
| Example 1 | | | |
| Comparative | 5 | 2.9 | 0.007 |
| Example 2 | | | |

From Table 2, it is seen that the insulating layer formed on the circuit substrate by using the adhesive film according to the present invention is excellent in surface flatness and, also, excellent in dielectric properties.

### Example 4

A circuit substrate was prepared from a FR 4 laminated sheet with copper clad on both faces having a copper foil of 35 μm and a board thickness of 0.2 mm and, then, the adhesive film obtained in Example 1 was vacuum-laminated on the thus-prepared circuit substrate by using a vacuum laminator attached with a heat-press under conditions of a temperature of 110° C., a pressure of 5 kgf/cm² (49×104 N/m²), a barometric pressure of 5 mmHg (6.7 hPa) or less, and a pressing period of time of 30 seconds and, then, heat-pressed for 60 seconds at a temperature of 110° C. under a pressure of 5 kgf/cm² (49×10⁴ N/m²) and, thereafter, lamination was performed on both faces of the circuit substrate. Subsequently, the PET film was removed and, then, the resultant circuit substrate was heat-cured for 30 minutes at 170° C., perforated by using a laser to form a via-hole and, thereafter, a surface of the resultant cured thermosetting resin composition was subjected to a roughening treatment by an alkaline oxidizing agent of a permanganate and, then, to electroless and electrolytic plating, to thereby obtain a 4-layer printed wiring board in accordance with a subtractive process. Thereafter, the resultant printed wiring board was subjected to an annealing treatment at 180° C. for 90 minutes. The peel strength of the conductive layer thus obtained was 0.7 kgf/cm (6.9×10² N/m). Further, measurement of the peel strength was evaluated in accordance with JIS C6481 and, on this occasion, the thickness of the plating thickness of the conductor was defined as 30 μm. The multilayer printed wiring board thus obtained was dipped in solder for 60 seconds at 260° C. and, then, solder thermal resistance was observed, to thereby find that no abnormalities such as delamination of the resin and peeling-off of the conductor were generated.

### INDUSTRIAL APPLICABILITY

A thermosetting resin composition according to the present invention, comprising, as a main component, a cyanate compound, is not only excellent in dielectric properties of a cured article thereof, but also, when it forms an insulating layer on a circuit substrate, the surface of the thus-formed insulating layer is excellent in flatness. Therefore, when the thermosetting resin composition according to the present invention or an adhesive film comprising the thermosetting resin composition are used, an insulating layer capable of forming a fine-pattern circuit which is excellent in dielectric properties can be introduced on the circuit substrate and, accordingly, the thermosetting resin composition according to the present invention is extremely useful as an insulating material for a multilayer printed wiring board.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A thermosetting resin composition, comprising:
(a) at least one aromatic cyanate compound having at least two cyanato groups in one molecule,
wherein said thermosetting resin composition exhibits a minimum melt viscosity of less than 15000 (poise) and a melt viscosity at 160° C. of 15000 (poise) or more when a dynamic viscoelasticity measurement is conducted under conditions of a measurement initiation temperature of 60° C., a temperature-raising speed of 5° C./minute, and a frequency of 1 Hz/deg.

2. The thermosetting resin composition according to claim 1, further comprising:
(b) at least one aromatic epoxy resin having at least two epoxy groups in one molecule.

3. The thermosetting resin composition according to claim 2, further comprising:
(c) at least one phenoxy resin having a weight-average molecular weight of from 5000 to 100000.

4. The thermosetting resin composition according to claim 2, further comprising:
(c) at least one phenoxy resin having a biphenyl skeleton having a weight-average molecular weight of from 5000 to 100000.

5. The thermosetting resin composition according to claim 2, wherein said (a) at least one aromatic cyanate compound and said (b) at least one aromatic epoxy resin are present in relative amounts such that a ratio of the epoxy groups of said (b) at least one aromatic epoxy resin to the cyanato groups of said (a) at least one aromatic cyanate compound in the thermosetting resin composition is from 1:0.5 to 1:3.

6. The thermosetting resin composition according to claim 3, wherein said (a) at least one aromatic cyanate compound having at least two cyanato groups in one molecule and said (b) at least one aromatic epoxy resin having at least two epoxy groups in one molecule are present in relative amounts such that a ratio of the epoxy groups of said (b) at least one aromatic epoxy resin to the cyanato groups of said (a) at least one aromatic cyanate compound in the thermosetting resin composition is from 1:0.5 to 1:3; and the phenoxy resin is present in an amount of from 3 to 40 parts by weight, based on 100 parts by weight of the total weight of said (b) at least one aromatic epoxy resin and said (a) at least one aromatic cyanate compound.

7. The thermosetting resin composition according to claim 1, wherein said minimum melt viscosity is less than 10000 (poise); and said melt viscosity at 160° C. is 20000 (poise) or more.

8. The thermosetting resin composition according to claim 1, wherein said minimum melt viscosity is less than 8000 (poise); and said melt viscosity at 160° C. is 50000 (poise) or more.

9. The thermosetting resin composition according to claim 1, wherein said minimum melt viscosity occurs at a temperature of from 80° C. to 150° C.

10. The thermosetting resin composition according to claim 1, wherein said minimum melt viscosity occurs at a temperature of from 90° C. to 140° C.

11. The thermosetting resin composition according to claim 1, wherein said minimum melt viscosity occurs at a temperature of from 90° C. to 130° C.

12. An adhesive film, comprising a layer of a thermosetting resin composition according to claim 1 formed on a supporting film.

13. A multilayer printed wiring board, which is prepared by a method comprising:
(1) laminating an adhesive film according to claim 12 on one face or both faces of a circuit substrate;
(2) thermally curing said thermosetting resin composition of said adhesive film to obtain an insulating layer;
(3) perforating said insulating layer, to obtain a perforated insulating layer;
(4) roughening a surface of said perforated insulating layer, to obtain a roughened insulating layer;
(5) forming a conductor layer on said roughened insulating layer; and
(6) forming a circuit on said conductor layer,
wherein said supporting film of said adhesive film is removed prior to said roughening a surface of said perforated insulating layer.

14. The multilayer printed wiring board according to claim 13, wherein said thermally curing is performed for a period of time in the range of from 20 minutes to 180 minutes at a temperature in the range of from 150° C. to 220° C.

15. The multilayer printed wiring board according to claim 13, wherein a difference between a convex and a concave on the surface of said insulating layer obtained by said thermally curing said thermosetting resin composition is 4.5 μm or less.

16. The multilayer printed wiring board according to claim 13, wherein said method further comprises:
(1′) removing said supporting film of said adhesive film after said laminating and before said thermally curing.

17. The multilayer printed wiring board according to claim 13, wherein said method further comprises:
(2′) removing said supporting film of said adhesive film after said thermally curing and before said perforating.

18. A method for producing a multilayer printed circuit board, comprising:
(1) laminating an adhesive film according to claim 12 on one face or both faces of a circuit substrate;
(2) thermally curing said thermosetting resin composition of said adhesive film to obtain an insulating layer;
(3) perforating said insulating layer, to obtain a perforated insulating layer;
(4) roughening a surface of said perforated insulating layer, to obtain a roughened insulating layer;
(5) forming a conductor layer on said roughened insulating layer; and
(6) forming a circuit on said conductor layer,
wherein said supporting film of said adhesive film is removed prior to said roughening a surface of said perforated insulating layer.

19. The method according to claim 18, wherein said thermally curing is performed for a period of time in the range of from 20 minutes to 180 minutes at a temperature in the range of from 150° C. to 220° C.

20. The method according to claim 18, wherein a difference between a convex and a concave on the surface of said insulating layer obtained by said thermally curing said thermosetting resin composition is 4.5 μm or less.

21. The method according to claim 18, wherein said method further comprises:
(1′) removing said supporting film of said adhesive film after said laminating and before said thermally curing.

22. The method according to claim 18, wherein said method further comprises:
(2′) removing said supporting film of said adhesive film after said thermally curing and before said perforating.
